(19) United States
(12) Patent Application Publication
(10) Pub. No.: US 2026/0143368 A1
(43) Pub. Date: May 21, 2026

(54) METHOD AND SYSTEM FOR TESTING A SPLIT BEARER FUNCTIONALITY OF A DEVICE-UNDER-TEST

(71) Applicant: Rohde & Schwarz GmbH & Co. KG, Munich (DE)

(72) Inventors: Andreas MICHL, Munich (DE); Masroor KHAN, New Delhi (IN)

(73) Assignee: Rohde & Schwarz GmbH & Co. KG, Munich (DE)

(21) Appl. No.: 18/950,499

(22) Filed: Nov. 18, 2024

(51) Int. Cl. H04W 24/08

(52) U.S. Cl. CPC H04W 24/08

(57) ABSTRACT

The present disclosure relates to a method for testing a split bearer functionality of a device-under-test, DUT, wherein the DUT comprises a transmission buffer. The method comprises: transmitting data from the DUT to a test system, wherein the DUT and the test system are adapted to transmit respectively receive the data in a split bearer mode; and verifying whether the data is transmitted by the DUT using only a first radio access technology, RAT, if the data volume in the transmission buffer is less than a threshold value, and whether the data is transmitted by the DUT using the first RAT and a second RAT if the data volume in the transmission buffer reaches or exceeds the threshold value.

### TECHNICAL FIELD

The disclosure relates to testing of wireless communication devices. More specifically, the disclosure relates to a method and a test system for testing a split bearer functionality of a device-under-test, such as a mobile phone.

### BACKGROUND ART

Split bearer is a technique applicable to Multi-RAT Dual Connectivity (MR-DC) scenarios where end-to-end data is split over different radio access technologies (RATs) in order to optimize the maximum data rate. Compared to master cell group (MCG) and secondary cell group (SCG) bearers, where end-to-end data is transferred only via one leg, the split bearer data gets split over two legs (e.g., over 4G and 5G networks) and hence benefits from the data transfer capacity of carriers pertaining to different RATs.

In general, there is no detailed specification that defines how a given amount of data is to be distributed over the individual RATs when executing a split bearer functionality. Thus, it is a vendor specific implementation detail to define the actual data split ratio.

However, there is an exception to this rule which affects data split ratio for uplink split bearers. In this scenario the mobile endpoint (e.g. a mobile phone) determines the split ratio but needs to follow a particular constraint imposed by the network. This constraint is defined by a specific data threshold value of a data buffer on the mobile device which needs to be reached before the data split is initiated by the device. This rule was introduced to avoid unnecessary allocation of transmission resources on the second leg and thereby causing additional scheduling overhead in the network if the amount of data that is transmitted can be handled sufficiently on the first leg only.

Network operators and manufacturers of mobile devices that implement such dual connectivity and split bearer functionalities want to test these device functions in order to ensure that the devices provide optimized connectivity and comply with data transmission in MR-DC scenarios.

### SUMMARY

Thus, there is a need to provide a method and a test system for testing a split bearer functionality of a DUT.

These and other objectives are achieved by the embodiments provided in the enclosed independent claims. Advantageous implementations of the present disclosure are further defined in the dependent claims.

According to a first aspect, the disclosure relates to a method for testing a split bearer functionality of a device-under-test (DUT), wherein the DUT comprises a transmission buffer. The method comprises: transmitting the data from the DUT to a test system, wherein the DUT and the test system are adapted to transmit respectively receive the data in a split bearer mode; and verifying whether the data is transmitted by the DUT using only a first radio access technology (RAT) if the data volume in the transmission buffer is less than a threshold value, and whether the data is transmitted by the DUT using the first RAT and a second RAT if the data volume in the transmission buffer reaches or exceeds the threshold value.

This achieves the advantage that the split bearer functionality of the DUT can be tested efficiently. In particular, a correct data distribution by an uplink split bearer can be verified.

The DUT can be a user equipment (UE), e.g. a mobile phone, the split bearer can be an uplink split bearer and the transmission buffer can be a send buffer. For instance, by means of the method it can be verified that for a given uplink split bearer threshold value, a mobile device complies with data transmission rules in certain MR-DC scenarios. A bearer can represent a path or route in the network between the UE and a 5G base station (gNodeB).

Using only a first RAT for data transmission may refer to using only a first leg within the first RAT for the transmission, and using the first and the second RAT for data transmission may refer to using the first leg and additionally a second leg within the second RAT for the transmission.

Herein, split bearer mode may refer to the capacity of the DUT and the test system to transmit and/or receive data via one or more RATs.

For example, the first RAT is LTE and the second RAT is 5G NR, or vice versa. Thus, the first leg can be an LTE leg and the second leg can be an NR leg.

In an implementation form of the first aspect, the method further comprises: measuring an increase of a data transmission rate from the DUT to the test system when the DUT uses the second RAT in addition to the first RAT.

For instance, the method comprises measuring the slope of data transmission speed increase caused by the second RAT respectively the second leg.

In an implementation form of the first aspect, the method further comprises: testing whether a data transmission rate from the DUT to the test system drops if the data is only transmitted using the first RAT compared to using the first and the second RAT.

In an implementation form of the first aspect, the method further comprises: generating the data in the DUT with at least one data generation rate. Alternatively, the data could also be generated in a different device with the at least one data generation rate and forwarded to the DUT. The thus generated data can then be transmitted from the DUT to the test system.

In an implementation form of the first aspect, the method further comprises: testing whether the data volume in the transmission buffer continues to increase if the data generation rate of the data in the DUT exceeds the channel capacities of both the first RAT and the second RAT.

In an implementation form of the first aspect, the method further comprises: testing whether the transmission buffer is completely filled if the data generation rate of the data in the DUT exceeds the channel capacities of the first and the second RAT over a certain period of time.

For example, the test system is configured to control the DUT to generate the data to be transmitted with the at least one data rate. The DUT can therefore execute a software application which acts as a data generator. The test system, or more specifically a control unit of the test system, can be connected to the DUT via a communication interface and can be configured to control the software application to generate the data with the at least one data rate.

In an implementation form of the first aspect, the DUT is controlled to generate the data with at least two different data generation rates. For instance, the data generation rate can be increased, decreased and/or kept constant for certain amounts of time while testing a DUT.

In an implementation form of the first aspect, a first data generation rate is lower than a channel capacity of the first RAT, and a second data generation rate is higher than a channel capacity of the first RAT.

In an implementation form of the first aspect, the method further comprises: using a scheduler to grant more or less resources to an uplink and/or a downlink channel between the DUT and the test system. In this way, the channel capacities of the first and/or the second RAT can be adapted.

According to a second aspect, the disclosure relates to a test system for testing a split bearer functionality of a device-under-test (DUT), wherein the DUT comprises a transmission buffer. The test system comprises: a control unit configured to control the DUT to transmit data to the test system; a receiver configured to receive the data from the DUT, wherein the receiver is configured to operate in a split bearer mode. The test system further comprises a processing unit configured to verify whether the data is transmitted by the DUT using only a first radio access technology (RAT) if the data volume in the transmission buffer is less than a threshold value, and whether the data is transmitted by the DUT using the first RAT and a second RAT if the data volume in the transmission buffer reaches or exceeds the threshold value.

In an implementation form of the second aspect, the control unit is further configured to control the DUT to generate the data with at least one data generation rate.

In an implementation form of the second aspect, the DUT executes a software application which acts as a data generator; wherein the control unit is connected to the DUT via a communication interface and is configured to control the software application to generate the data with the at least one data rate.

In an implementation form of the second aspect, the processing unit is configured to measure an increase of a data transmission rate from the DUT to the test system when the DUT uses the second RAT in addition to the first RAT.

In an implementation form of the second aspect, the processing unit is configured to test whether a data transmission rate from the DUT to the test system drops if the data is only transmitted using the first RAT compared to using the first and the second RAT.

In an implementation form of the second aspect, the processing unit is configured to test whether the data volume in the transmission buffer continues to increase if the data generation rate of the data in the DUT exceeds the channel capacities of both the first RAT and the second RAT.

In an implementation form of the second aspect, the processing unit is configured to test whether the transmission buffer is completely filled in case the data generation rate of the data in the DUT exceeds the channel capacities of the first and the second RAT over a certain period of time.

### BRIEF DESCRIPTION OF THE DRAWINGS

The above-described aspects and implementation forms of the present disclosure will be explained in the following description of specific embodiments in relation to the enclosed drawings, in which:

FIG. 1 shows steps of a method for testing a split bearer functionality of a DUT according to an embodiment;

FIG. 2 shows further steps of the method for testing a split bearer functionality of a DUT according to an embodiment;

FIG. 3 shows an uplink data stream which is split between two RATs according to an embodiment;

FIG. 4 shows data generation and data transmission rates over time according to an embodiment;

FIG. 5 shows a schematic diagram of a test system for testing a split bearer functionality of a DUT according to an embodiment; and

FIG. 6 shows a schematic diagram of a test system for testing a split bearer functionality of a DUT according to an embodiment.

### DETAILED DESCRIPTIONS OF EMBODIMENTS

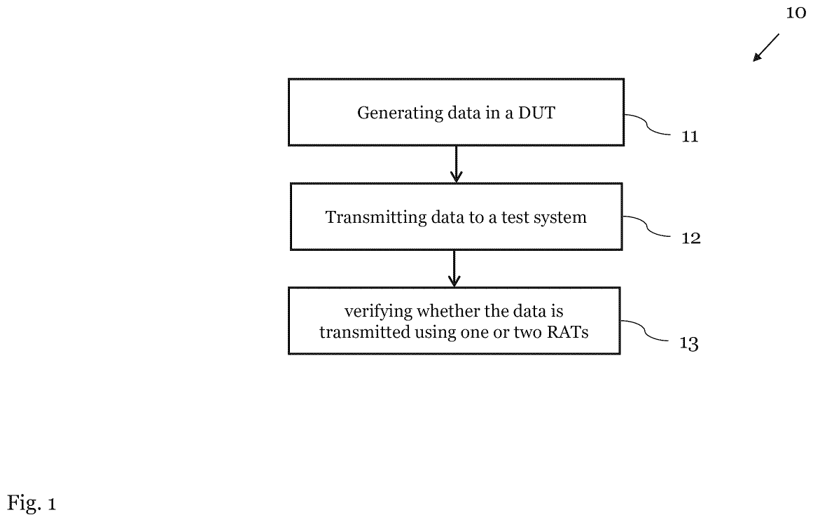

FIG. 1 shows steps of a method 10 for testing a split bearer functionality of a DUT according to an embodiment. The DUT, e.g. a mobile phone, can be operated in a split bearer mode in which it transmits data over two RATs (radio access technologies) if a data volume in a transmission buffer of the DUT has reached a threshold value.

The method 10 comprises the steps of: transmitting 12 the data from the DUT to a test system, wherein the DUT and the test system are adapted to transmit respectively receive the data in a split bearer mode; and verifying 13 whether the data is transmitted by the DUT using only a first RAT if the data volume in the transmission buffer is less than a threshold value, and whether the data is transmitted by the DUT using the first RAT and a second RAT if the data volume in the transmission buffer reaches or exceeds the threshold value.

The DUT can be a user equipment (UE), e.g. a mobile phone with a split bearer functionality. The split bearer functionality may refer to the function of transmitting and/or receiving data via one or two different RATs simultaneously.

The transmission from the DUT to the test system, according to step 12, can be an uplink transmission. The transmission buffer of the DUT can be a split bearer transmission buffer and/or a send buffer. Data which generated by the DUT can be temporarily stored in the transmission buffer before it is transmitted at a certain data rate. For instance, the buffer is implemented by a data storage in the DUT.

The method can comprise the further step of generating 11 the data in the DUT with at least one data generation rate prior to the transmission 12 to the test system. However, the data generation 11 with the at least one data generation rate could also be carried out elsewhere, i.e. in a different device, and the data could be forwarded to the DUT for transmission 11 to the test system.

By means of the method 10, it can be verified 13 that the DUT only uses the second RAT for and uplink data transmission if the threshold value of the transmission buffer is reached. Typically, mobile network operators (MNOs) generally want to avoid that too many RATs are being used unnecessarily by UEs in the network. With the method 10, it can be verified that UEs only use two RATs when required.

For instance, the DUT can transmit 12 the data via a first leg in the first RAT if the data volume in the transmission buffer is less than the threshold value, and via the first leg and a second leg in the second RAT if the data volume in the transmission buffer reaches or exceeds the threshold value. Herein, a leg is a connection path within a RAT, used to transmit data.

The verification 13 can be carried out by the test system. For example, the test system detects the reaching (or almost reaching) of the threshold value in the DUT by detecting that the DUT has switched from a transmission 12 via a single RAT respectively leg (e.g., 4G) to a transmission 12 via two RATs respectively legs (e.g., 4G and 5G NR). For detecting this change in transmission behavior of the DUT, the exact threshold value must not be known by the test system.

The DUT can be controlled to generate 11 the data at certain data generation rates. For instance, the DUT executes an application or software which acts as a data generator. This application or software can be controlled by the test system.

In an example, the DUT is controlled to generate the data with at least two different data generation rates while carrying out the method 10. For instance, a first data generation rate for generating the data can be lower than a channel capacity of the first RAT and a second data generation rate for generating the data can be higher than the channel capacity of the first RAT. By switching from the first to the second data generation rate, the transmission buffer of the DUT can be gradually filled and the use of the second RAT, when reaching the threshold filling level, can be tested (as will be explained in more detail below).

In addition or alternatively, the channel capacity of the first and/or the second RAT respectively leg can be adapted. For instance, if and when the filling level of the transmission buffer reaches the threshold value depends on the channel capacity of the first RAT for a given data generation rate.

For example, a scheduler can be used to grant more or less resources to an uplink and/or a downlink channel between the DUT and the test system. The scheduler can be a scheduler of the DUT or of the test system.

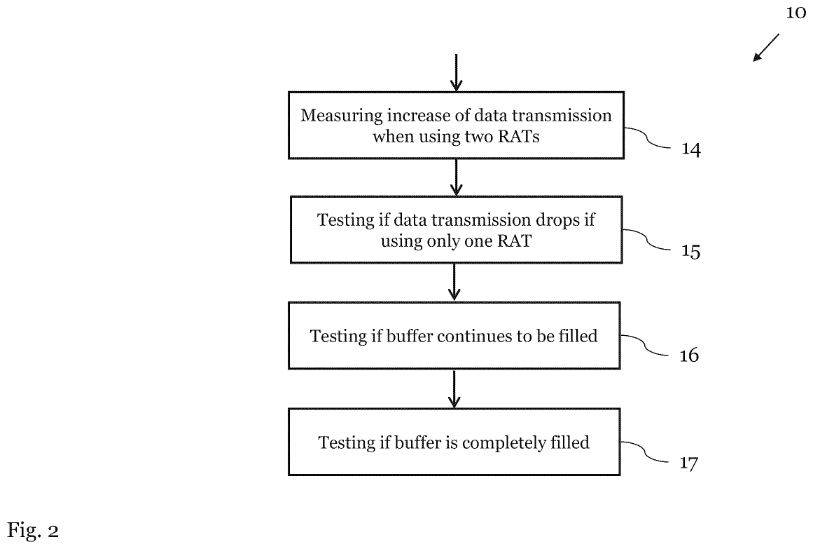

FIG. 2 shows further exemplary steps of the method 10 for testing the split bearer functionality of the DUT.

The method 10 can comprise the further step of measuring 14 an increase of a data transmission rate from the DUT to the test system when the DUT uses the second RAT in addition to the first RAT (i.e., when data volume in the transmission buffer has reached the threshold value). This can be done by measuring a slope of a data transmission speed increase due to the transmission via the second leg.

In addition or alternatively, the method 10 can comprise: testing 15 whether a data transmission rate from the DUT to the test system drops if the data is only transmitted using the first RAT compared to using the first and the second RAT. For instance, if the buffer filling level drops below the threshold value, the DUT can switch from using both RATs to using only the first RAT (also referred to as: primary RAT).

Furthermore, the method 10 can comprise the step of testing 16 whether the data volume in the transmission buffer continues to increase (i.e., the buffer continuous to be filled) if the data generation rate of the data in the DUT exceeds the channel capacities of both the first RAT and the second RAT. To conduct this test, the channel capacities of both RATS can be decreased and/or the DUT can be controlled to increase its data generation rate to a value that exceeds the channel capacities of both RATs.

In this way, it can also be tested 17 whether the transmission buffer is filled completely if the data generation rate of the data in the DUT exceeds the channel capacities of the first and the second RAT over a certain period of time.

In addition, the method may also comprise a step of determine the size of the transmission buffer. An exemplary routine for determining the buffer size comprises the following steps: transmitting a data stream with a transmitting bit rate by means of the DUT (via the first and/or second leg), wherein the data stream is loaded into the transmit buffer during said transmission; receiving the data stream with a receiving bit rate at a receiver device (e.g., at the test system); detecting a difference between the transmitting bit rate and the receiving bit rate over time; monitoring a packet loss at the receiver side; detecting a time at which a packet error rate (PER) at the receiver side increases above a threshold based on the monitored packet loss; and calculating a size of the buffer based on a difference between an amount of data transmitted by the DUT and an amount of data received by the receiver device from the start of the transmission until the detected time of the PER increase. The packet loss can be determined with a suitable method, such as an Iperf UDP measurement.

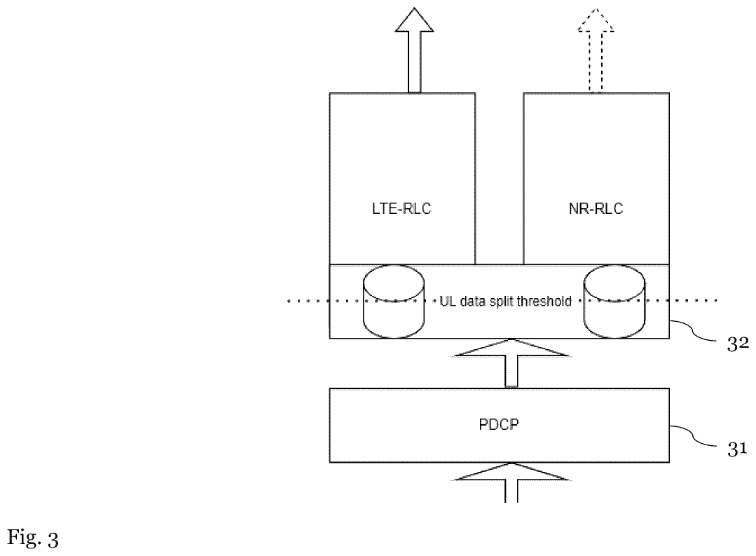

FIG. 3 shows an exemplary uplink data stream from the DUT to the test system which is split between two RATs.

The exemplary uplink data stream passes through a PDCP layer 31 where it gets “split up” and “filled” in the transmission buffer 32, e.g. a combined LTE-RLC and NR-RLC buffer. This represents a specialized dual connectivity scenario referred to as EN-DC. Once a filling level the buffer 32 reaches the configured UL split bearer threshold (as indicated by the dotted line), a data transmission starts on the second leg (e.g. NR). Before the buffer is filled to the threshold level, the data is only transmitted via the first leg (e.g. LTE).

The above described method 10 for testing the split bearer functionality of the DUT can be implemented in different ways, e.g. in the form of different test routines. Two such test routines will be discussed in the following. Thereby it is assumed that the following parameters can be controlled during testing: (a) the RATs channel capacities (in particular of the first leg), (b) the data generation rate in the DUT, (c) the threshold value V_{threshold} of the transmission buffer. Further, it is assumed that it is possible to (d) measure the received data on the individual RATs (i.e., legs) via the test system, e.g., a system simulator.

A first test routine, which is also referred to as “Sanity Check”, can be used to test whether the DUT is capable of switching from a transmission via only the first RAT to a transmission via the first and the second RAT when the data volume in the transmission buffer has reached or exceeds the threshold value.

For instance, the first test routine comprises the following steps:
A.1) Fixing the channel capacity (a) of the first RAT respectively first leg to a high value which is low enough to guarantee stable and reliable uplink data rates. E.g. 100 Mbit/s.
A.2) Fixing the threshold value (c) of the transmission buffer to some value.
A.3) Setting the data generation rate (b) at the DUT to the same or a slightly lower value as (a). E.g. Dg=24 Mbit/s. Based on this configuration the buffer filling state in the DUT should be near zero.
A.4) Using the data received at the test system (d) to verify there is no data conveyed via the second RAT respectively second leg regardless of the measurement duration.
A.5) Setting the data generation rate (b) at the DUT to a significantly higher value as (a). E.g. Dg=200 Mbit/s.
A.6) Using (d) to verify that there is data conveyed via the second leg at some point in time. The expected time Tm for the first data packets on the second leg and hence the expected measurement timeout can be expressed by the following formula:

$$Tm = {V}_{threshold} / ( Dg - Dc 1 )$$

A second test routine, which is also referred to as “Closed Loop test”, can be used to test whether the switching of the data transmission from the first leg to the first and second leg takes place at the correct time (e.g., at the correct buffer filling state).

For instance, the second test routine comprises the following steps which are carried out for some or all possible threshold values (c) of the transmission buffer:
B.1) Fixing the channel capacity (a) for the first RAT respectively the first leg to a high value which is however low enough to guarantee stable and reliable uplink data rates. E.g. Dc1=100 Mbit/s.
B.2) Setting the data generation rate (b) at the DUT to at a slightly higher value as (a). E.g. Dg=110 Mbit/s. Note, the difference between Dc1 and Dg can be varied to create higher deltas and hence shorten the measurement time or to create lower deltas in order to achieve more precise measurement results.
B.3) Observing a data rate on the second RAT respectively the second leg via the test system (d) and measuring the time between starting the data generator of the DUT and receiving the first data packets on the second leg. Based on this configuration the buffer filling state on the DUT should grow over time until it reaches the threshold value. At this time it is expected to receive data packets via the second leg.
B.4) If data was received after some time (dt): Calculating whether the threshold value (c) corresponds to the amount of data calculated by the following formula:

$${V}_{buf} = dt * ( Dg - Dc 1 ) .$$

If the calculated and the configured value differ given some tolerance deviation, an appropriate verdict can be reported. Note that the delta between data generation rate Dg and data transmission rate Dc corresponds to the data rate at which the buffer gets filled. Alternatively, instead of using the mentioned formula to calculate the buffer filling state, a buffer status report could be requested to get the DUT buffer filling level reported back.
B.5) If no data was received via the second leg regardless of the measurement time, an appropriate verdict can be reported.

In addition or alternatively, the DUT can be configured to communicate the transmission buffer filling status to the test system.

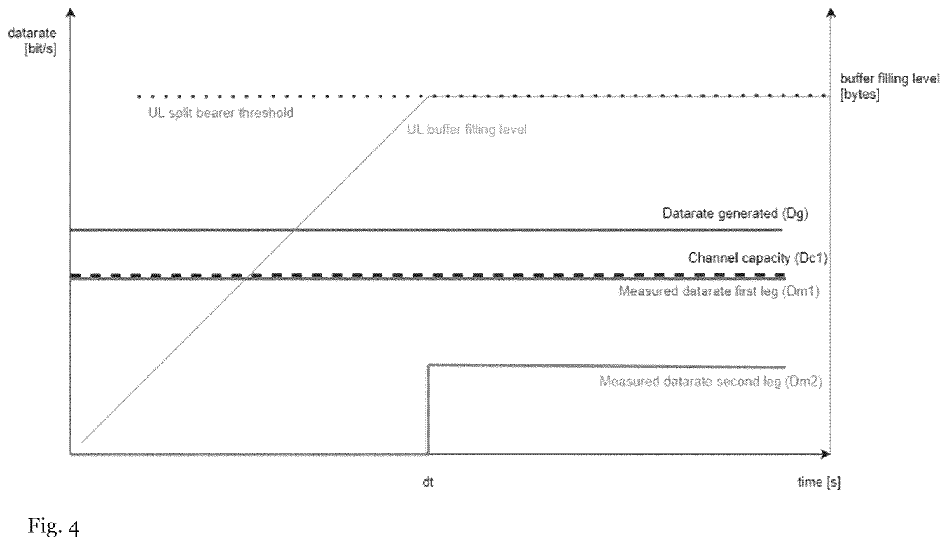

FIG. 4 shows data generation and data transmission rates over time according to an embodiment. In particular, FIG. 4 shows a UL split bearer traffic distribution graph while carrying out the second test routine (Closed loop test).

As can be seen in FIG. 4, when the generated data rate Dg exceeds the channel capacity Dc1 for the first leg, the UL buffer filling level increases linearly until the buffer threshold value is reached at time dt. During this time, the test system receives data via the first leg with a measured data rate Dm1 that essentially corresponds to the channel capacity Dc1.

When the UL threshold value of the buffer is reached, the DUT starts transmitting data via the second leg (that uses the second RAT). Thus, the test system starts receiving data via the second leg with a measured data rate Dm2. Based on the measured time dt, the data rate Dg and the channel capacity Dc1, the threshold value of the transmission buffer can be calculated, e.g. using the above formula.

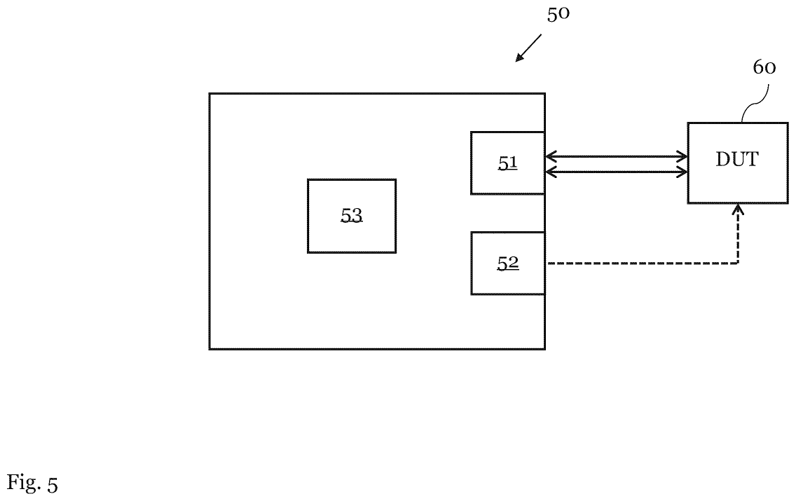

FIG. 5 shows a schematic diagram of the test system 50 for testing a split bearer functionality of the DUT 60 according to an embodiment. The DUT 60 comprises the transmission buffer 32 as, e.g., shown in FIG. 3.

The test system 50 comprises a control unit 52 configured to control the DUT 60 to transmit data to the test system 50; a receiver 51 configured to receive the data from the DUT 60, wherein the receiver 51 is configured to operate in a split bearer mode; and a processing unit 53. The processing unit 53 can be configured to verify whether the data is transmitted by the DUT 60 using only the first RAT if the data volume in the transmission buffer is less than a threshold value, and whether the data is transmitted by the DUT 60 using the first RAT and the second RAT if the data volume in the transmission buffer reaches or exceeds the threshold value.

The control unit 52 can further be configured to control the DUT 60 to generate the data with at least one data generation rate prior to the transmission.

For instance, the DUT 60 executes a software application which acts as a data generator. The control unit 52 can be connected to the DUT via a communication interface and can be configured to control the software application to generate the data with the at least one data rate.

The processing unit 53 can be configured to measure an increase of a data transmission rate from the DUT 60 to the test system 50 when the DUT 60 uses the second RAT in addition to the first RAT.

The processing unit 53 can further be configured to test whether a data transmission rate from the DUT 60 to the test system 50 drops if the data is only transmitted using the first RAT compared to using the first and the second RAT.

In addition or alternatively, the processing unit 53 can be configured to test whether the data volume in the transmission buffer continues to increase if the data generation rate of the data in the DUT 60 exceeds the channel capacities of both the first RAT and the second RAT. For instance, the processing unit 53 is configured to test whether the transmission buffer is completely filled in case the data generation rate of the data in the DUT exceeds the channel capacities of the first and the second RAT over a certain period of time.

The test system 50 can be configured to carry out the method as shown in FIGS. 1 and 2.

The processing unit 53 can be a microprocessor or an ASIC.

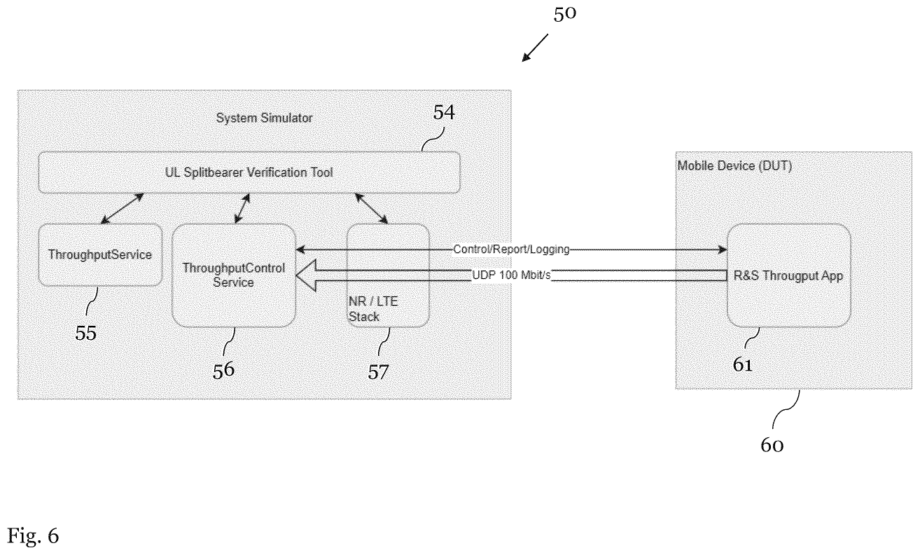

FIG. 6 shows a schematic diagram of the test system 50 according to an embodiment.

The test system 50 can comprise a ‘UL Split Bearer Verification Tool’ 54. This tool 54 can be implanted as a software that is, e.g., executed by the processor 53 of the system 50. Verification Tool 54 can be designed to control the following entities of the test system 50:
1) An NR/LTE stack 57. Here, NR and LTE represent two RATs which might take part in dual connectivity scenarios. The system 50 and method 10 are applicable but not limited to these two RATs. The Verification Tool 54 can configure the RAT stacks to enable a stable uplink data transmission channel granting a defined data rate. This data rate can be referred to as the ‘granted uplink data rate’. Apart from that the Verification Tool 54 can make use of buffer status reports (BSR), which are supported by some RATs and which provide, on request, information about the buffer occupancy on the DUT end. Finally, the Verification Tool 54 can configure the uplink split bearer threshold value as described above.
2) A ‘Throughput Control Service’ 56 is a service that allows to control and serve the data generation application that is executed by the DUT. The Control Service 56 can cater for a large set of throughput related testing problems. For the above-described system 50 and method 10, its capability to create an UDP server and report a received UDP data rate can be utilized. For instance, the control unit 52 can at least in part be formed by the Throughput Control Service 56.
3) A ‘Throughput Application’ 61 installed and running on the mobile device may allow, among other things, to set up a UDP client application and generate a defined UDP uplink data rate. This data rate can be configured remotely via the Throughput Control Service 56.
4) A ‘Throughput Service’ 55 is a service that can report the observed data rate on various OSI stack layers (like MAC, RLC, PDCP) from different RATs.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above-described embodiments. Rather, the scope of the disclosure should be defined in accordance with the following claims and their equivalents.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the present disclosure may have been disclosed with respect to only one of several implementations, such feature may be combined with one or more other features of the other implementations as may be desired and advantageous for any given or particular application.

1. A method for testing a split bearer functionality of a device-under-test, DUT, wherein the DUT comprises a transmission buffer, the method comprising:
transmitting the data from the DUT to a test system, wherein the DUT and the test system are adapted to transmit respectively receive the data in a split bearer mode; and
verifying whether the data is transmitted by the DUT using only a first radio access technology, RAT, if the data volume in the transmission buffer is less than a threshold value, and whether the data is transmitted by the DUT using the first RAT and a second RAT if the data volume in the transmission buffer reaches or exceeds the threshold value.

2. The method of claim 1, further comprising:
measuring an increase of a data transmission rate from the DUT to the test system when the DUT uses the second RAT in addition to the first RAT.

3. The method of claim 1, further comprising:
testing whether a data transmission rate from the DUT to the test system drops if the data is only transmitted using the first RAT compared to using the first and the second RAT.

4. The method of claim 1, further comprising:
generating the data in the DUT with at least one data generation rate.

5. The method of claim 4, further comprising:
testing whether the data volume in the transmission buffer continues to increase if the data generation rate of the data in the DUT exceeds the channel capacities of both the first RAT and the second RAT.

6. The method of claim 4, further comprising:
testing whether the transmission buffer is completely filled if the data generation rate of the data in the DUT exceeds the channel capacities of the first and the second RAT over a certain period of time.

7. The method of claim 4,
wherein the DUT is controlled to generate the data with at least two different data generation rates.

8. The method of claim 7,
wherein a first data generation rate is lower than a channel capacity of the first RAT, and wherein a second data generation rate is higher than a channel capacity of the first RAT.

9. The method of claim 1, further comprising:
using a scheduler to grant more or less resources to an uplink and/or a downlink channel between the DUT and the test system.

10. The method of claim 1, wherein the first RAT is LTE and the second RAT is 5G NR, or vice versa.

11. A test system for testing a split bearer functionality of a device-under-test, DUT, wherein the DUT comprises a transmission buffer, comprising:
a control unit configured to control the DUT to transmit data to the test system;
a receiver configured to receive the data from the DUT, wherein the receiver is configured to operate in a split bearer mode; and
a processing unit configured to verifying whether the data is transmitted by the DUT using only a first radio access technology, RAT, if the data volume in the transmission buffer is less than a threshold value, and whether the data is transmitted by the DUT using the first RAT and a second RAT if the data volume in the transmission buffer reaches or exceeds the threshold value.

12. The test system of claim 11,
wherein the control unit is further configured to control the DUT to generate the data with at least one data generation rate.

13. The test system of claim 12,
wherein the DUT executes a software application which acts as a data generator;
wherein the control unit is connected to the DUT via a communication interface and is configured to control the software application to generate the data with the at least one data generation rate.

14. The test system of claim 11,
wherein the processing unit is configured to measure an increase of a data transmission rate from the DUT to the test system when the DUT uses the second RAT in addition to the first RAT.

15. The test system of claim 11,
wherein the processing unit is configured to test whether a data transmission rate from the DUT to the test system drops if the data is only transmitted using the first RAT compared to using the first and the second RAT.

16. The test system of claim 12,
wherein the processing unit is configured to test whether the data volume in the transmission buffer continues to increase if the data generation rate of the data in the DUT exceeds the channel capacities of both the first RAT and the second RAT.

17. The test system of claim 12,
wherein the processing unit is configured to test whether the transmission buffer is completely filled in case the data generation rate of the data in the DUT exceeds the channel capacities of the first and the second RAT over a certain period of time.
